(19) United States
(12) Patent Application Publication
(10) Pub. No.: US 2014/0019244 A1
(43) Pub. Date: Jan. 16, 2014

(54) Generating A Ranked List of Offers in A Shopping Query

(71) Applicants: Suman Gundapaneni, Hyderabad (IN); Abhishek Bapna, Gachibowli (IN); Akash Katare, Madinaguda (IN); Sunny Goyal, Miyapur (IN); Krishna Prasad Manchikalapati, Nizampet (IN); Mayank Talati, Gachibowli (IN)

(72) Inventors: Suman Gundapaneni, Hyderabad (IN); Abhishek Bapna, Gachibowli (IN); Akash Katare, Madinaguda (IN); Sunny Goyal, Miyapur (IN); Krishna Prasad Manchikalapati, Nizampet (IN); Mayank Talati, Gachibowli (IN)

(21) Appl. No.: 13/664,385

(22) Filed: Oct. 30, 2012

Related U.S. Application Data
(63) Continuation of application No. PCT/IN2012/000497, filed on Jul. 13, 2012.

(51) Int. Cl. G06Q 30/02

(52) U.S. Cl. 705/14.54

(57) ABSTRACT

An improved offer ranking system can provide a computer-implemented method for ranking offers in an online shopping search. The method comprises receiving one or more offers for a product; associating the offers with the product in a database; assigning cash values for any segments of the offer that are not monetary; determining an equivalent value for the offer; receiving a shopping query from a user network device; accessing the offers for the product; ranking the offers for the product based on the equivalent values of the offers; presenting the ranked offers to the user network device.

### CROSS-REFERENCE TO RELATED APPLICATIONS

This application claims priority to international patent application no. PCT/IN2012/000497, entitled “Generating A Ranked List Of Offers In A Shopping Query” and filed Jul. 13, 2012. The entire contents of the above-identified priority application are hereby fully incorporated herein by reference.

### TECHNICAL FIELD

The present disclosure relates to online shopping queries, and more particularly to a method for generating a ranked list of offers associated with the search results of a shopping query.

### BACKGROUND

The retail market has seen significant growth in online shopping since the advent of the Internet. On the Internet, users may search for, locate, and purchase nearly everything that can be purchased at a physical marketplace.

Online shopping websites often use shopping search engines to allow a user to search for a specific product or group of products. The shopping search engines store products and characteristics of the product. For example, a search engine may store a database of products that contains product descriptions, product user ratings, merchants offering the products, product identifications such as a model number, and other product characteristics.

A search engine may additionally store offers for the product, such as coupons, discounts, rebates, or other offers. The offer details may be provided to the search engine by offer providers, such as the marketing system for the product, retailers, “daily deal” offer providers, and others. A search engine also can perform a web search to gather current offers and product information from product websites, retailers, and other shopping websites.

When a user receives product offers, the user desires to know which offer is the best or most valuable. The most valuable offer is often difficult for a user to determine because the offers may not be easy to compare. For example, while some offers may be for a specific discount, other offers may include a free warranty or free installation. Users would be desirous of a way to determine which offer is the best.

### SUMMARY

An aspect of the present invention provides a computer-implemented method for ranking offers in an online shopping search. The method comprises receiving one or more offers for a product; associating the offers with the product in a database; assigning cash values for any segments of the offer that are not monetary; determining an equivalent value for the offer; receiving a shopping query from a user network device; accessing the offers for the product; ranking the offers for the product based on the equivalent values of the offers; presenting the ranked offers to the user network device.

Another aspect of the present invention provides a computer program product that is installed on a server located in a search engine system to rank offers in an online shopping search. The computer program product includes a non-transitory computer-readable storage device having computer-readable program instructions stored therein. The computer-readable program instructions include computer program instructions for receiving one or more offers for a product; associating the offers with the product in a database; assigning cash values for any segments of the offer that are not monetary; determining an equivalent value for the offer; receiving a shopping query from a user network device; accessing the offers for the product; ranking the offers for the product based on the equivalent values of the offers; presenting the ranked offers to the user network device.

These and other aspects, objects, features and advantages of the exemplary embodiments will become apparent to those having ordinary skill in the art upon consideration of the following detailed description of illustrated exemplary embodiments, which include the best mode of carrying out the invention as presently presented.

### BRIEF DESCRIPTION OF THE DRAWINGS

FIG. 1 is a block diagram depicting a system for generating a ranked list of offers in an online shopping query, in accordance with certain exemplary embodiments.

FIG. 2 is a block flow diagram depicting a method for displaying a ranked list of offers, in accordance with certain exemplary embodiments.

FIG. 3 is a block flow diagram depicting a method for a search engine system to rank offers related to an online shopping query, in accordance with certain exemplary embodiments.

### DETAILED DESCRIPTION OF THE EXEMPLARY EMBODIMENTS

### Overview

The exemplary embodiments provide a search engine system that is operating on an online shopping website. The search engine system may employ a user interface to allow a user to enter keywords or phrases. The keywords may be a single word relating to the product for which the user would like to shop, two or more related words, or a phrase relating to the product. As used throughout the specification, any combination of one or more keywords or phrases will be referred to simply as “keywords”. A user may open the online shopping website and enter keywords related to the product on the search engine system interface. As used throughout the specification, the term “product(s)” should be interpreted to include tangible and intangible products, as well as services. The user may also enter product model numbers or other identifiers to search for a specific product.

The search engine system maintains a database or other catalog of products. The search engine system can receive offers from online offer providers. The offer provider may be a marketing system for a product, retailers, “daily deal” offer providers, and others. The offer providers may transmit offers and other product information to the search engine system.

Additionally or alternatively, the search engine system can crawl the Internet and gather deals, coupons, promotions, and other offers from the websites of offer providers and other suitable locations and store the products and offers in the database.

Additionally or alternatively, the search engine system can conduct a web search over the Internet and gather offers and product details at the time of the query entry. The search engine can extract offers from the search results.

The search engine system analyzes each offer for a product. Some offers may include a sale price, a rebate, a coupon, free or discounted installation, free or discounted warranties, “buy one get one free” offers, included accessories, or other types of offers. The search engine seeks to rank the product offers to provide the best deal to the user. With many different types of offers, the search engine cannot simply list the offer with the biggest discount or lowest sale price. In certain instances, the warranty may be more valuable than the discount or the accessories may be more valuable than a coupon.

The search engine system can determine an adjusted price for each offer. The search engine system can determine the price of any non-monetary offers. For example, the search engine system can determine the equivalent cash value of items such as installation, warranties, accessories, or any other non-monetary offers. The search engine system can establish the values of the non-monetary offers from any available source. Sources may include, but not be limited to, established pricing from the manufacturer website, industry pricing standards, established estimates, input from search engine system operators, or any other suitable resource.

The search engine system can use the equivalent cash value of non-monetary offers to determine an equivalent price for the product. For example, a particular TV at a merchant may be offered for $1000, but includes a free 2-year warranty. The search engine system can determine that the 2-year warranty is valued at $100. The search engine system can thus establish the equivalent price of the TV at $900. Another merchant may be offering the same TV for $1100, but may be including a $300 rebate. The search engine system can establish the equivalent price of the TV at $800.

The search engine system can compare the equivalent costs of the offers for a certain product and rank the offers based on the equivalent costs. For example, the products may be ranked from the lowest equivalent cost to the highest equivalent costs.

In an alternate embodiment, the search engine system can assign a score to the selling price of the product. The search engine system can additionally assign a score to the other aspects of the offer. The aspects receiving a score may include, but not be limited to, rebates, coupons, warranties, installation, discounts, how closely a user query matches product offer details, or other suitable offer components.

The search engine system can assign a total score to an offer by adding the selling price score to the scores of any other offer components. The scores can be compared and the offers ranked accordingly.

The search engine system can display the results of the search and the offer ranking or transmit the results and the offer ranking to the online shopping system. The results can be displayed to the user to assist the user in selecting the best offer for a product.

The functionality of the exemplary embodiments will be explained in more detail in the following description, read in conjunction with the figures illustrating the program flow.

### System Architecture

Turning now to the drawings, in which like numerals represent like (but not necessarily identical) elements throughout the figures, exemplary embodiments of the invention are described in detail.

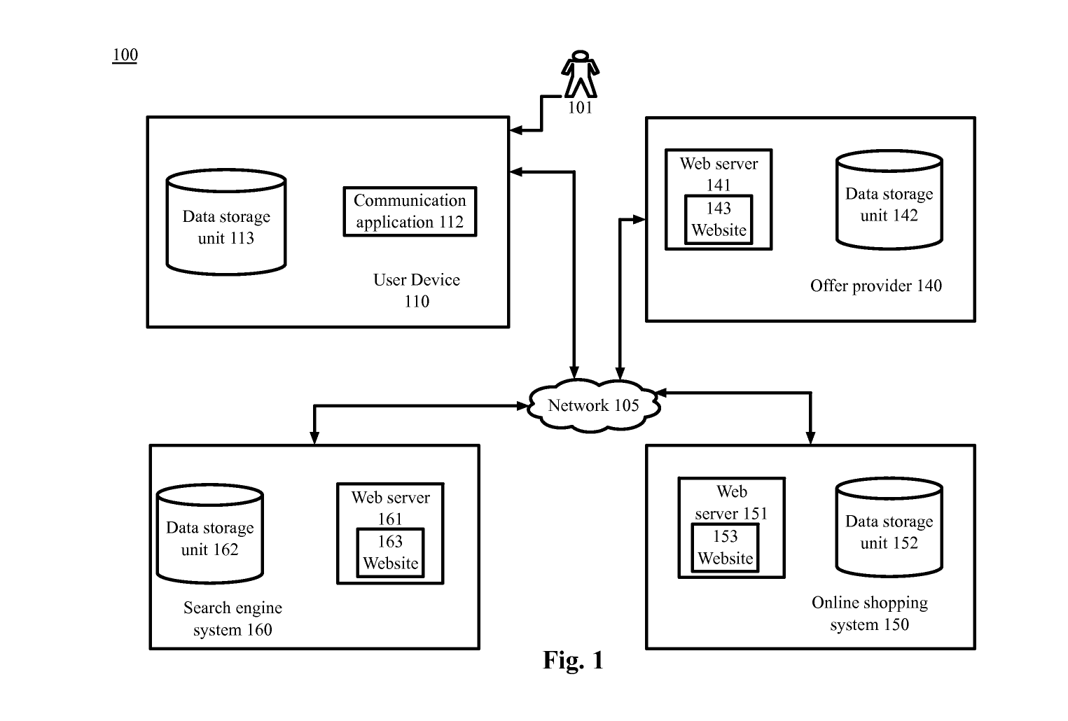

FIG. 1 is a block diagram depicting a system 100 for generating a ranked list of offers in an online shopping query, in accordance with certain exemplary embodiments.

As depicted in FIG. 1, the system 100 includes network devices 110, 140, 150, and 160 that are configured to communicate with one another via one or more networks 105.

Each network 105 includes a wired or wireless telecommunication means by which network devices (including devices 110, 140, 150, and 160) can exchange data. For example, each network 105 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 110, 140, 150, and 160 includes a device having a communication module capable of transmitting and receiving data over the network 105. For example, each network device 110, 140, 150, and 160 can include a server, desktop computer, laptop computer, tablet computer, smart phone, handheld computer, personal digital assistant (“PDA”), or any other wired or wireless, processor-driven device. In the exemplary embodiment depicted in FIG. 1, the network devices 110, 140, 150, and 160 are operated by end-users or consumers, offer provider operators, online shopping system operators, and search engine system operators, respectively.

The user 101 can use the communication application 112, such as a web browser application or a stand-alone application, to view, download, upload, or otherwise access documents or web pages via a distributed network 105. The network 105 includes a wired or wireless telecommunication system or device by which network devices (including devices 110, 140, 150, and 160) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The user device 110 includes a data storage unit 113 accessible by the communication application 112. The exemplary data storage unit 113 can include one or more tangible computer-readable media. The data storage unit 113 can be stored on the user device 110 or can be logically coupled to the user device 110. For example, the data storage unit 113 can include on-board flash memory and/or one or more removable memory cards or removable flash memory.

The search engine system 160 can be used to search the Internet for websites and other Internet accessible data for the purpose of online shopping or other online searching functions. The search engine system 160 may collect the websites or other online locations of the searched product and display the results to the user. The search engine system server 161 represents the computer-implemented system that the search engine system 160 employs to perform Internet searches. The search engine system server 161 can include a set of computer-readable program instructions, for example, using JavaScript, that enable the search engine system 160 to interact with the online shopping system 150 and the offer provider system 140 to search documents, websites, and other data, submit search results and query suggestions, store product databases, and generate equivalent costs. The search engine system website 163 may represent any web-based interface that allows users to interact with the search engine system 160 to enter search data and receive search results and ranked lists of offers. The search engine system 160 user interface can interact with the website application of the online shopping system 150 or be embodied as a companion application of the website application and execute within the website application. In certain exemplary embodiments, the search engine system 160 can be implemented in a stand-alone configuration in which the user 101 can search multiple merchant online shopping systems 150. In certain exemplary embodiments, the search engine system 160 can be a function of the online shopping system 150.

The online shopping system 150 utilizes an online shopping system server 151. The online shopping system server 151 may represent the computer implemented system that the online shopping system 150 employs to configure user accounts, create the online marketplace, host the search engine interface, communicate with the search engine system 160, and complete transactions with the user device 110. The online shopping system website 153 may represent any web-based interface that allows users to interact with the online shopping system 150 to search for products, browse products, and make purchases. The online shopping system 150 may include a data storage unit 152 accessible by the server 151 of the online shopping system 150. The data storage unit 152 can include one or more tangible computer-readable storage devices.

The offer provider 140 can employ an offer provider web server 141. The server 141 may represent the computer implemented system that the offer provider 140 employs to host the offer provider website 143. The offer provider website 143 may host the offers for which the search engine system 160 is searching. The offer provider may host offers, sales, retail outlets, daily deals, product manufacturers, product marketing systems, or other system that is related to the product being searched and can provide products for purchase or offers for a product. The offer provider 140 may transmit offers and other product information to the search engine via a message over the network 105, email, text, or any other suitable connection. The offer provider 140 may include a data storage unit 142 accessible by server 141 of the offer provider 140. The data storage unit 142 can include one or more tangible computer-readable storage devices.

It will be appreciated that the network connections shown are exemplary and other means of establishing a communications link between the computers and devices can be used. Moreover, those having ordinary skill in the art having the benefit of the present disclosure will appreciate that the user device 110, offer provider 140, online shopping system 150, and search engine system 160 illustrated in FIG. 1 can have any of several other suitable computer system configurations. For example, a user device 110 can be embodied as a mobile phone or handheld computer may not include all the components described above.

### System Process

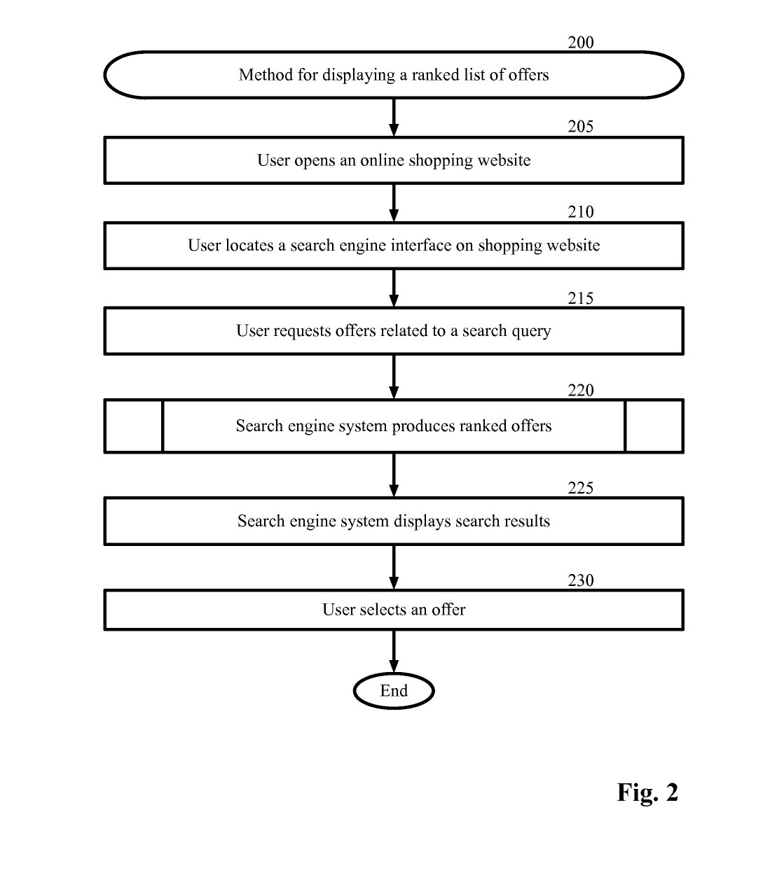

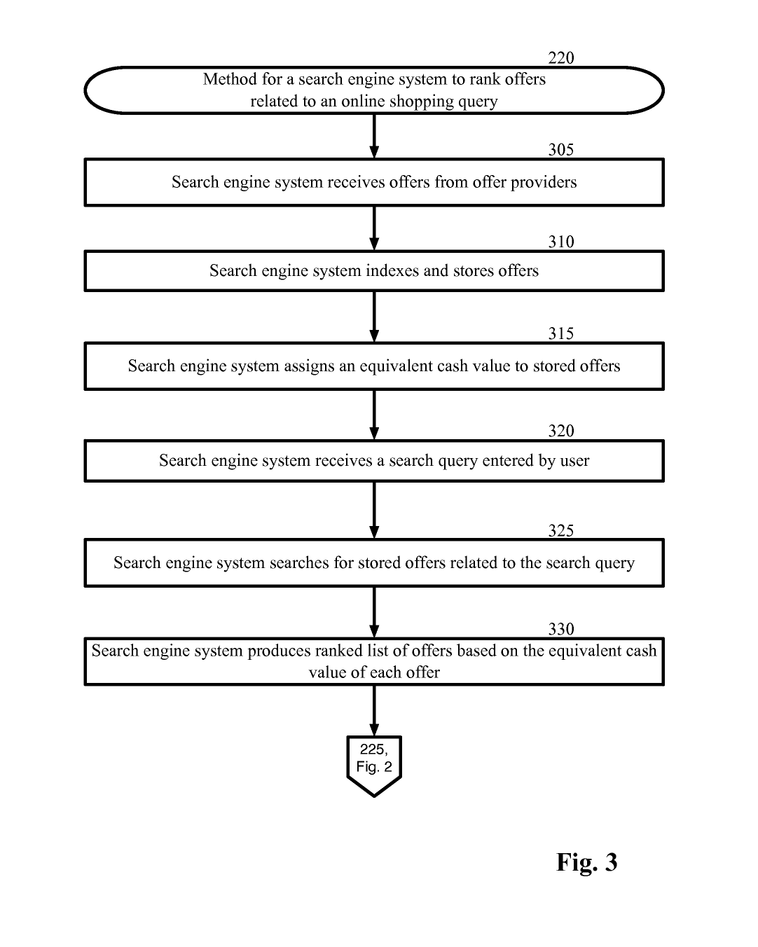

The components of the exemplary operating environment 100 are described hereinafter with reference to the exemplary methods illustrated in FIGS. 2-3. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 2 is a flow chart depicting a method 200 for displaying a ranked list of offers in an online shopping search, in accordance with certain exemplary embodiments.

With reference to FIGS. 1 and 2, in block 205, the user 101 opens a website 153 on an online shopping system 150. The user may access the website 153 by a mobile network device, (for example, notebook computer, tablet computer, netbook computer, personal digital assistant (PDA), video game device, GPS locator device, cellular telephone, smartphone, or other mobile device), a personal computer, or other appropriate technology that includes or is coupled to a web browser application module 112, such as GOOGLE'S CHROME, MICROSOFT'S INTERNET EXPLORER, or MOZILLA'S FIREFOX.

In block 210, the user 101 locates a search engine user interface on the shopping website 153. The search engine system 160 may be embodied as a companion application of the website 153 and execute within the website 153 application. Alternatively, in an alternate embodiment, the website 153 may simply host the user interface of the search engine system 160 and allow the search engine system 160 to operate as a separate application. Alternatively, the search engine system 160 may be a function of the online shopping system 150. Alternatively, the online shopping system 150 may be a function of the search engine system 160.

In block 215, the user 101 utilizes a user interface of the website 153 to enter a keyword or phrase relating to the item for which they are searching. The keywords may be a single word relating to the product for which the user would like to shop, two or more related words, or a phrase relating to the product. As used throughout the specification, any combination of one or more keywords or phrases will be referred to simply as “keywords”. The user 101 may enter further details about a product to identify the product such as a model number, part number, or other description.

In block 220, the search engine system 160 generates ranked offers and produces product search results. Block 220 will be discussed in more detail with reference to FIG. 3, which depicts a method 220 for a search engine system to rank offers related to an online shopping query.

In block 225, the search engine system 160 provides the ranked offers to the user 101. The offers may be displayed to the user 101 on a user interface of the search engine system 160, on a user interface of the online shopping system 150, or any other suitable interface. In an alternative embodiment, the search engine system 160 communicates the search results to the user device 110, which presents the search results to the user 101 via a user interface of the user device 110.

In block 230, the user 101 can select the offer or other result that most closely matches the result for which the user 101 was shopping.

FIG. 3 is a flow chart depicting a method 220 for a search engine system 160 to rank offers related to an online shopping query, in accordance with certain exemplary embodiments.

With reference to FIGS. 1 and 3, in block 305, the search engine system 160 receives or gathers offers and product details from offer providers 140. The search engine system can receive offers from online offer providers 140. The offer provider 140 may be a marketing system for a product, retailers, “daily deal” offer providers, and others. The offer providers 140 may transmit offers and other product information to the search engine system 160.

Additionally or alternatively, the search engine system 160 can traverse the Internet and gather deals, coupons, promotions, and other offers from the websites of offer providers 140 and other suitable locations and store the products and offers in the database.

Additionally or alternatively, the search engine system 160 can conduct a web search over the Internet and gather offers and product details at the time of the query entry. The search engine 160 can extract offers from the search results.

The offer provider 140 may transmit offers and other product information to the search engine 160 via a message over the network 105, email, text, feed, or any other suitable connection.

In block 310, the search engine system 160 maintains a database or other catalog of products. The search engine system 160 analyzes each offer for a product. Some offers may include a sale price, a rebate, a coupon, free or discounted installation, free or discounted warranties, “buy one get one free” offers, included accessories, or other types of offers. The search engine 160 seeks to rank the product offers to provide the best deal to the user 101. With many different types of offers, a ranking system that only lists the offer with the biggest discount or lowest sale price would undervalue an offer that contains significant non-monetary aspects. In certain instances, a warranty may be more valuable than the discount or free accessories may be more valuable than a monetary coupon.

Additionally or alternatively, the database may be maintained on the online shopping system 150.

In block 315, the search engine system 160 assigns an equivalent cash value to the offers and stores the offers and product details in the database. If an offer includes only the product specified in the search query, then the equivalent cash value of that offer is the price of the offer. If an offer includes the product specified in the search query plus other items bundled therewith, then the equivalent cash value of that offer includes the price of the specified product and the value of all the monetary and non-monetary items included therewith. Exemplary items that may be bundled with a specified product include, but are not limited to, products, services, discounts, rebates, warranties, or other monetary or non-monetary items.

The search engine system 160 can determine the equivalent cash value of any items bundled with the specified product in an offer for the specified product. For example, the search engine system 160 can establish the values of the non-monetary offers from any available source. Sources may include, but are not limited to, established pricing from the manufacturer website, industry pricing standards, established estimates, input from search engine system operators, or any other suitable source.

The search engine system 160 can use the equivalent cash value of items bundled in an offer to determine an equivalent price for the specified product in the offer. In an exemplary embodiment, the equivalent cash value for the specified product can be established by subtracting the value of all bundled items from the price for the offer. For example, a particular TV at a merchant may be offered for $1000, but includes a free 2-year warranty. In this case, the search engine system 160 can determine that the 2-year warranty is valued at $100. The search engine system 160 can establish the equivalent cash value of the TV at $900. Another merchant may be offering the same TV for $1100, but may be including a $300 rebate. In this case, the search engine system 160 can establish the equivalent cash value of the TV at $800. Another merchant may be offering the same TV for $950, but may be including a “free” microwave. The search engine system 160 can determine that the microwave is valued at $200. In this case, the search engine system 160 can establish the equivalent cash value of the TV at $750.

In block 320, the search engine system 160 receives a search query from a user 101, as discussed previously with reference to block 215 of FIG. 2. The user 101 enters the search query into the user interface provided by the search engine system 160 or the online shopping system 150.

In block 325, the search engine system 160 can access the products and the related offers stored in the database that most closely match the search query. The search engine system 160 can alternatively or additionally perform a search of the Internet for offers and merchants at the time of the search query. If the search engine system 160 performs a search of the Internet for related offers, or otherwise identifies offers that have not yet been valued by the search engine system 160, then the search engine 160 can perform block 315 for each such offer.

In block 330 the search engine system 160 compares the equivalent value of the offers for a certain product and ranks the offers based on the equivalent value. For example, the products may be ranked from the lowest equivalent cash value for the product to the highest equivalent cash value for the product.

In an alternate embodiment, the search engine system 160 can assign a score to the selling price of the product in an offer. The search engine system 160 can additionally assign a score to each item bundled with the offer. The bundled items receiving a score may include, but not be limited to, rebates, coupons, warranties, products, services, installation, discounts, or other suitable offer components. The scoring system can be based on any rules or algorithm configured by the search engine system operators or others. In a certain embodiment, the scores can be based on the price for which an offer component can be purchased or is otherwise valued.

The search engine system 160 can assign a total score to an offer by adding the selling price score, other offer component scores, the score of how close user query matches product offer details, and any other relevant factors affecting the score. The scores can be compared and the products ranked accordingly.

From block 330, the method 220 returns to block 225 with respect to FIG. 2.

### General

Users may, in appropriate circumstances, limit or otherwise affect the operation of the features disclosed in the specification. For example, users may be given an initial opportunity to opt-in or opt-out of the collection or use of certain data or the activation of certain features. In addition, a user may change the manner in which the features are employed, including for situations in which a user may have concerns regarding his privacy. Instructions may be provided to users to notify the users regarding policies about the use of information, including personally identifiable information and receipt information, and manners in which the users may affect such use of information.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as the act may be performed by more than one computer. The inventive functionality of the invention will be explained in more detail in the following description, read in conjunction with the figures illustrating the program flow.

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for ranking offers in an shopping search, comprising:
receiving, by a computer, a plurality of offers for a product, each of the offers comprising a price for the respective offer;
associating, by the computer, the offers with the product in a database;
for each of the offers, assigning, by the computer, a cash value for any components of the offer that are in addition to the product, and determining, by the computer, an equivalent value for the offer based on the price of the offer adjusted by the cash value of each component of the offer that is in addition to the product;
receiving, by the computer, a shopping query from a user network device, wherein the query is associated with the product;
ranking, by the computer, the offers for the product based on the equivalent values of the offers; and
presenting, by the computer, the ranked offers to the user network device in response to receiving the query.

2. The computer-implemented method of claim 1, wherein each component of the offer that is in addition to the product comprises at least one of a rebate, coupon, discount, accessory, warranty, installation, and an additional product.

3. The computer-implemented method of claim 1, wherein, for each offer, the equivalent value is determined by subtracting the cash value of each component of the offer that is in addition to the product from the price of the offer.

4. The computer-implemented method of claim 1, wherein the ranking comprises a list of the offers from the lowest equivalent value to the highest equivalent value.

5. The computer-implemented method of claim 1, wherein the cash value for any components of the offer that are in addition to the product is determined from data accessed from one or more of a manufacturer website, an industry pricing standard, an online shopping website, or an input from search engine system operators.

6. The computer-implemented method of claim 1, wherein the computer executes on an online shopping website.

7. A computer program product, comprising:
a non-transitory computer-readable storage device having computer-readable program instructions embodied thereon to rank offers in an online shopping search, the computer-readable program instructions comprising:
computer program instructions to receive a plurality of offers for a product, each of the offers comprising a price for the respective offer;
computer program instructions to associate the offers with the product in a database;
computer program instructions to assign a score for any components of each offer that is in addition to the product;
computer program instructions to assign a score for the price of the offer;
computer program instructions to determine a total score for the offer, the total score being generated by adding the component scores and the price score;
computer program instructions to receive a shopping query from a user network device, wherein the query is associated with the product;
computer program instructions to rank the offers for the product based on the scores of the offers; and
computer program instructions to present the ranked offers to the user network device in response to receiving the query.

8. The computer program product of claim 7, wherein each component that is in addition to the product comprises at least one of a rebate, coupon, discount, accessory, warranty, installation, and an additional product.

9. The computer program product of claim 7, wherein the ranking is comprised of listing the offers from the highest score to the lowest score.

10. The computer program product of claim 7, wherein the score for any components of the offer that are in addition to the product is determined from data accessed from one or more of a manufacturer website, an industry pricing standard, an online shopping website, or an input from search engine system operators.

11. The computer program product of claim 7, wherein the computer executes on an online shopping website.

12. A system to use a one-time code to rank offers in an online shopping search, the system comprising:
a storage resource;
a network module; and
a processor communicatively coupled to the storage resource and the network module, wherein the processor executes application code instructions that are stored in the storage resource and that cause the system to:
receive a plurality of offers for a product, each of the offers comprising a price for the respective offer;
associate the offers with the product in a database;
for each of the offers, assign a cash value for any components of the offer that is in addition to the product;
for each of the offers, determine, an equivalent value for the offer based on the price of the offer adjusted by the cash value of each component of the offer that is in addition to the product;
receive a shopping query from a user network device, wherein the query is associated with the product;
rank the offers for the product based on the equivalent values of the offers; and
present the ranked offers to the user network device in response to receiving the query.

13. The system of claim 12, wherein each component that is in addition to the product comprises at least one of a rebate, coupon, discount, accessory, warranty, installation, and an additional product.

14. The system of claim 12, wherein for each offer, the equivalent value is determined by subtracting the cash value of each component of the offer that is in addition to the product from the price of the offer.

15. The system of claim 12, wherein the ranking comprises a list of the offers from the lowest equivalent value to the highest equivalent value.

16. The system of claim 12, wherein the cash value for any components of the offer that are in addition to the product is determined from data accessed from one or more of a manufacturer website, an industry pricing standard, an online shopping website, or an input from search engine system operators.
